(19) United States
(12) Patent Application Publication
(10) Pub. No.: US 2005/0116131 A1
(43) Pub. Date: Jun. 2, 2005

(54) Support device

(76) Inventor: Michael Samuel, Campbellfield Victoria (AU)

Correspondence Address: PURDUE LAW OFFICES;2735 N. HOLLAND-SYLVANIA ROAD, SUITE B-2, TOLDEO, OH, 43615, US

(21) Appl. No.: 10/676,767

(22) Filed: Oct. 1, 2003

Related U.S. Application Data
(63) Continuation-in-part of application No. PCT/AU02/00393, filed on Mar. 28, 2002.

(30) Foreign Application Priority Data
Apr. 2, 2001 (AU) PR4150
Jan. 9, 2002 (AU) PR9891

(51) Int. Cl. F16M 13/00

(52) U.S. Cl. 248/357; 52/293.1; 248/309.4

(57) ABSTRACT

This invention relates to a device for providing temporary support to a structure such as a formwork member. The invention includes a support device (1) for supporting a formwork member (16) adjacent to formwork surface. A securing means (12) is associated with the structure being operable for securing the support device to the formwork surface. A switching means (3) is provided for switching the securing means (12) between an operating condition whereby the securing means (12) secures the support device to the formwork surface, and a non operating condition whereby the securing means (12) is not securing the support device to the formwork surface. Advantageously, the support device (1) can be easily and predictably activated and de-activated.

### FIELD OF THE INVENTION

This invention relates to a device for providing temporary support to a structure. The device is particularly, but not exclusively, suited to temporary support of a formwork structure. The device has a particular application in the concrete construction industry and it will be convenient to hereinafter describe the invention in relation to this particular application. It should be appreciated however that the device has wider application.

### BACKGROUND TO THE INVENTION

A popular form of concrete construction includes horizontally pre-casting of panels which after curing are subsequently “tilted up” into position. The panels are generally cast on a formwork surface. It should be appreciated that the quality of the surface finish of the panel is dictated by the quality of the surface on which it is cast. In this regard the formwork surface may be formed from smooth timber, metal or cured concrete.

The length, width and depth of the panel is defined by appropriately located edge forms. The depth or thickness of the panel is defined by the height of the edge forms. The freshly poured or wet concrete creates substantial forces which act upon the edge forms, Furthermore, it is popular to vibrate the concrete whilst it is wet to eliminate any voids and such vibration will create further forces which act upon the edge forms. Accordingly it is normal for the edge forms to be supported continuously or at intervals along their length to restrict these forces. The supports have previously been welded, bolted or nailed to the formwork surface. This style of support is time consuming to install and dismantle once the panel has cured. Furthermore the formwork surface is generally damaged when the support is removed. It should be appreciated that where any subsequent panel is of greater dimension than previous panels the wet concrete will be poured onto the damaged formwork surface, and as such will produce a panel of inferior surface quality. Alternatively the formwork surface will have to be repaired which further adds to the costs.

Where the formwork surface is formed from metal it is possible to use a support device including a magnet securing means for supporting the edge forms. It should be appreciated that the magnetic force required to resist the forces of the wet concrete has a direct effect on the forces required in detaching the magnetic securing means from the formwork surface. Mechanisms have been designed to facilitate detaching the magnet from the formwork surface, however they tend to be over technical in their design with excessive moving parts, which mechanisms are not entirely suitable for the corrosive environment of construction. Furthermore, the mechanisms tend to include resilient means for counteracting any magnetic attractive force, and given that the relative strength of both the resilient means and the magnetic force tends to alter over the life of the magnet or resilient means, this can tend to produce a support device which may perform unpredictably.

It would be advantageous to provide a support means which was more suitable for use in the corrosive construction environment. It would be further advantageous to provide a support device which functioned predictably.

### SUMMARY OF THE INVENTION

According to a first aspect of the present invention there is provided a support device for supporting a formwork member adjacent to formwork surface, including:
a support structure positionable in use adjacent the formwork surface;
a securing means associated with the structure being operable for securing the support device to the formwork surface, and being movable relative to the support structure;
a switching means being rotatably switchable for switching the securing means between an operating condition whereby the securing means secures the support device to the formwork surface, and a non operating condition whereby the securing means is not securing the support device to the formwork surface,
wherein in use the formwork member located adjacent the formwork surface is supported by the support device.

Preferably, the switching means moves the securing means so that in the non-operating condition, the securing means is spaced from the formwork surface. It is preferred that the securing means include a magnet member. This is particularly suitable where the formwork surface is a ferromagnetic material—such as steel.

In one preferred embodiment, the switching means rotates about a rotation axis, the rotation axis being an axis substantially parallel with the formwork surface.

In one preferred embodiment, the switching means includes a cam member which is connected to the securing means and includes a cam surface which engages the structure, whereby movement of the cam member causes the securing means to switch between the operating and non-operating conditions. Preferably, the cam member engages the support structure along a cam surface, so that movement of the cam member causes the securing means to switch between the operating and non-operating conditions. It is preferred that the cam surface be curved or bevelled, however this is not essential. It is still further preferred that the rotational movement of the cam member can be facilitated by a lever extending from the cam member. It is still further preferred that the lever be detachably connected to the cam member.

The support structure is preferably in the form of a housing which at least in part surrounds the securing means. The support structure preferably includes an upper surface against which the cam surface may bear, the cam member being located on the outside surface of the support structure. It is further preferred to provide a bearing plate between the cam surface and the upper surface, however this is not essential.

It is further preferred that the switching means includes a link member linking the cam member with the securing means. The link member could be formed with the securing means, or alternatively the link member could have complimentary engagement with the securing means. In one preferred embodiment, the link member is in the form of a shank having a male threaded portion for engaging a female threaded recess in the magnet, however this is not essential. It is still further preferred that the link member include an aperture for receiving a pin of the cam member, which pin connects the link member with the cam member. The pin preferably provides an axis about which the cam member may rotate.

Preferably, the support device includes alignment means for guiding the movement of the securing means relative to the support structure, between the non-operating and operating conditions. The alignment means may be in the form of at least one resilient means for engaging the interior surface of the support structure and the securing means. Preferably, the resilient means extends from the top surface of the securing means. Alternatively, the resilient means may extend from the interior surface of the structure. In another form, the alignment means may be in the form of complimentary grooves and projections formed on the interior of the support structure and the exterior of the securing means.

The support structure preferably includes means for facilitating connection of the support structure to the formwork member. This means may be in the form of a flange provided with at least one aperture to receive a fastening means, for fastening the formwork member to the flange. Preferably, in use the flange extends in a direction transverse to the formwork surface. Alternatively, in use the flange extends in a direction substantially perpendicular to the formwork surface. Preferably, the at least one aperture existing through the flange is adapted to facilitate adjustment of the fastening means relative to the support device and the formwork member. Preferably, the at least one aperture is adapted to facilitate lateral and longitudinal adjustment of the fastening means relative to the flange. More preferably, this angle is about 45 degrees relative to the formwork surface when the support device is in use. This allows for variations in the formwork surface to be compensated when connecting the support device to the formwork member.

It is preferred that the support device includes tilt adjustment means varying the tilt or level of the support structure relative to the formwork surface. This is particularly useful when the formwork surface is uneven. The tilt adjustment means is preferably located on a face of the support structure opposite a face that engages the formwork member.

In one preferred embodiment, the support structure includes:
an engaging side having engaging means for engaging the formwork member; and at least one non-engaging side so that in the non-operating condition, the engaging side is spaced from the formwork surface; and in the operating condition, the support structure is forced toward the formwork surface, the structure applying a force on the engaging means to apply force on the formwork member toward the formwork surface.

In at least one preferred embodiment, the non-engaging side includes an adjustable height means for adjusting the height of the non-engaging side of the support structure, relative to the engaging side of the support structure. Preferably, the adjustable height means includes a plate extending from a non-engaging side; at least one shank extending from the plate towards the formwork surface; and at least one complimentary foot, each foot being adjustable along each shank. Preferably, the shank and foot have complimentary threads to make adjustment easier. Preferably, each foot includes an outer surface that is flexible/elastic, so that in the operating condition, the foot reduces the likelihood of damaging the formwork surface.

Preferably, adjustment of the foot allows the angle of the formwork member to be adjusted relative to the formwork surface. In one form, only one non-engaging side having the adjustable height means is included and located on the side opposite the engaging face. This allows for rotation of the support structure in a direction toward the formwork member. Alternatively, all the other sides of support structure have non-engaging sides having the adjustable height means. This allows for the sides adjacent the engaging side to be raised higher than the side opposite the engaging side, allowing for rotation of the support structure in a direction away from the formwork member.

Preferably, the engaging means includes a wedge located on the engaging side of the support structure which engages a complimentary wedge associated with the formwork member. The complimentary wedge may be formed integrally with the formwork member.

In an alternate preferred embodiment, the support device may be formed integrally with the formwork member.

It is still further preferred that the support structure be provided with a handle means facilitating manipulation of the support device. Preferably, the handle means is located on an upper surface of the support structure. Preferably the handle means is located adjacent the flange (when provided). Preferably, the handle means is pivotable relative to the support structure.

The securing means is preferably a magnet member. The support structure is preferably a housing that is made from a non-magnetic material, such as stainless steel, or aluminum. Other components should be made of suitably durable materials as required. The wedge of the engaging means, flange of the connection means and plate member may be glued, bolted or fixed to the housing of the support structure by any other appropriate means.

### BRIEF DESCRIPTION OF THE DRAWINGS

It will be convenient to hereinafter describe the invention in greater detail by reference to the accompanying drawings showing example embodiments of the invention. The particularity of the drawings and the related detailed description is not to be understood as superseding the generality of the preceding broad description of the invention.

FIG. 1 is a perspective view of a preferred form of the support device.

FIG. 2 is a perspective exploded view of the preferred support device from FIG. 1.

FIG. 3A is a cross-sectional view through section A-A of FIG. 1 showing a first embodiment of the invention where the securing means is in the non-operating condition.

FIG. 3B is a cross-sectional view through section A-A of FIG. 1 of the first embodiment of the invention where the securing means is between the operating and non-operating conditions.

FIG. 3C is a cross-sectional view through section A-A of FIG. 1 showing the first embodiment of the invention where the securing means is in the operating condition.

FIG. 4A is a cross-sectional view through section A-A of FIG. 1 showing a second embodiment of the invention where the securing means is in the operating condition.

FIG. 4B is a cross-sectional view through section A-A of FIG. 1 showing the second embodiment of the invention where the securing means is in between the non-operating and operating conditions.

FIG. 4C is a cross-sectional view through section A-A of FIG. 1 showing another embodiment of the invention where the securing means is in the non-operating condition.

FIG. 5 is a perspective view of the preferred form of the support device in use connected to a formwork member.

FIG. 6 is a cross-sectional view of another embodiment of the support device in the non-operating condition.

FIG. 7 is a cross-sectional view of the support device of FIG. 6 in the operating condition.

### DETAILED DESCRIPTION OF THE PREFERRED EMBODIMENTS

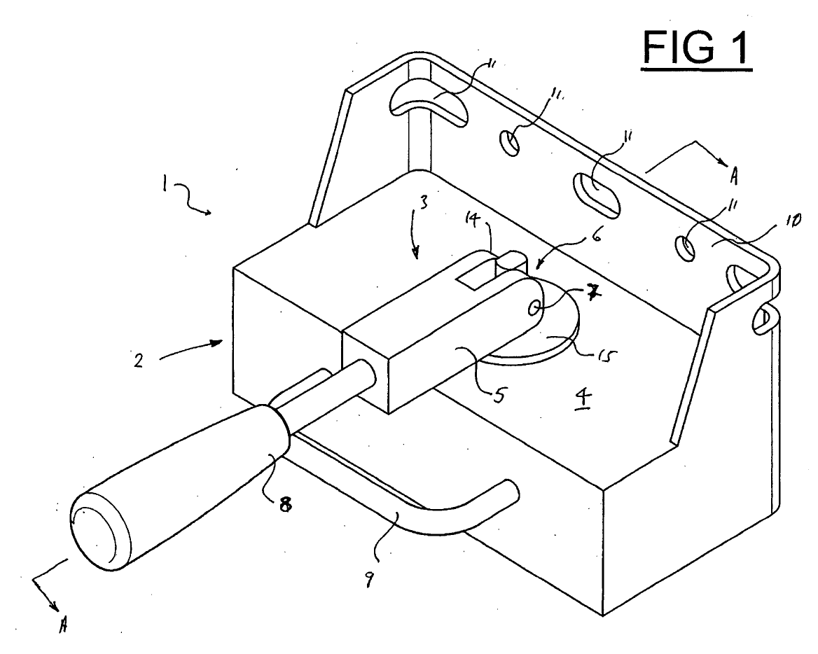

Referring now to FIG. 1 there is illustrated a preferred form of a support device 1 according to the invention. The support device 1 illustrated includes a support structure 2 with a switching means 3 located adjacent an upper surface 4 of the structure 2. The switching means 3 illustrated includes a cam member 5 connected to a link member 6 via a pin 7. The switching member 3 illustrated also includes a lever 8 extending from an end of the cam member 5 for facilitating operation of the switching means 3, which operation will be discussed later on in the specification.

The support structure 2 also includes a handle 9 for facilitating manipulation of the support device 1, which handle 9 extends from a surface of the structure extending substantially transverse to the upper surface 4. Clearly the location of the handle 9 is merely preferred and it is possible that the handle 9 may be located on an alternative position of the structure 2.

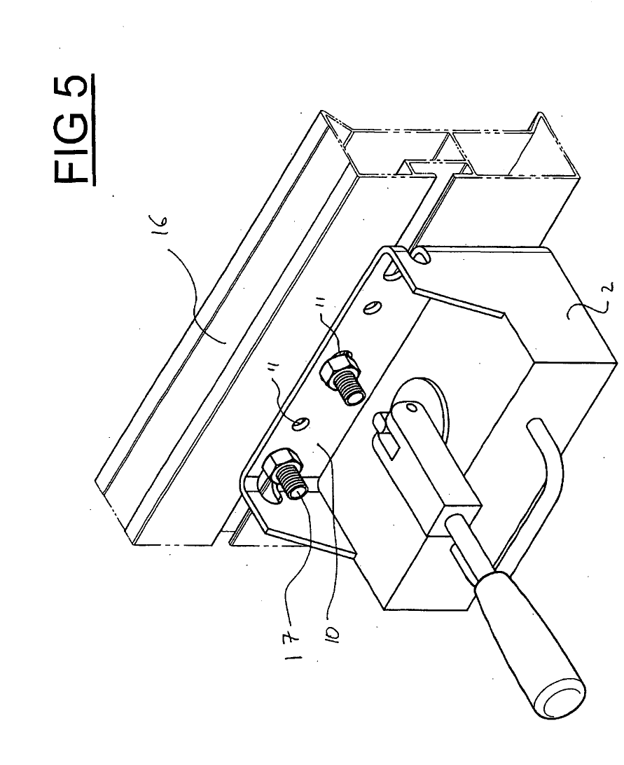

The structure 2 illustrated also includes a flange 10 having a plurality of 15 apertures 11 extending therethrough. The apertures 11 are provided for facilitating connection of the support device 1 to a formwork member (see FIG. 5), which connection will be described later on in the specification.

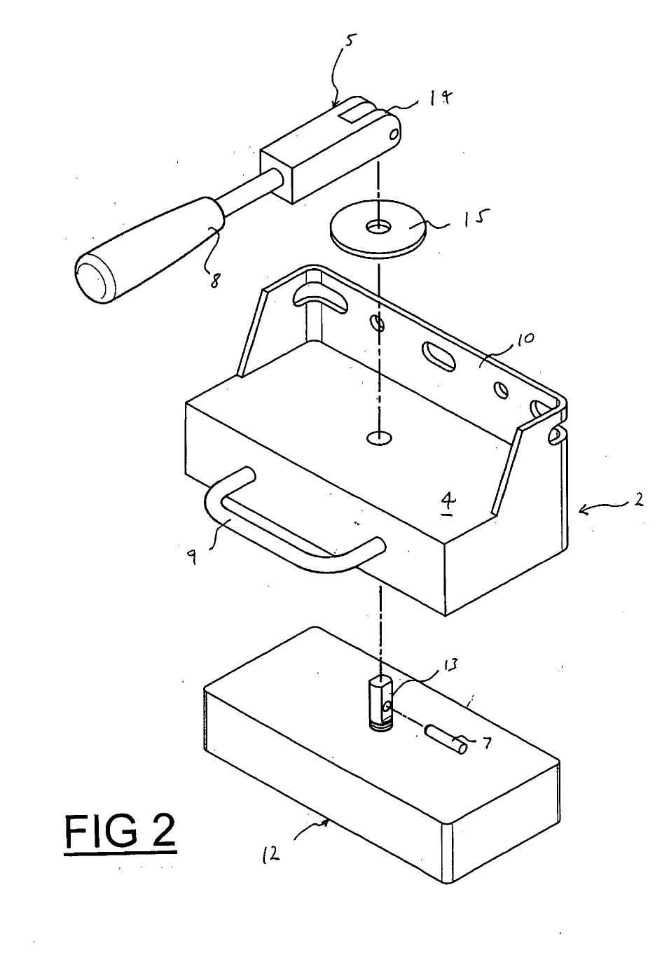

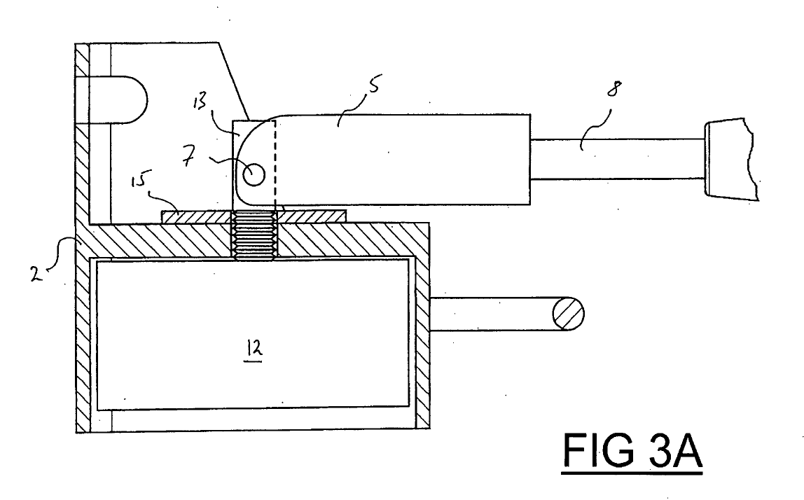

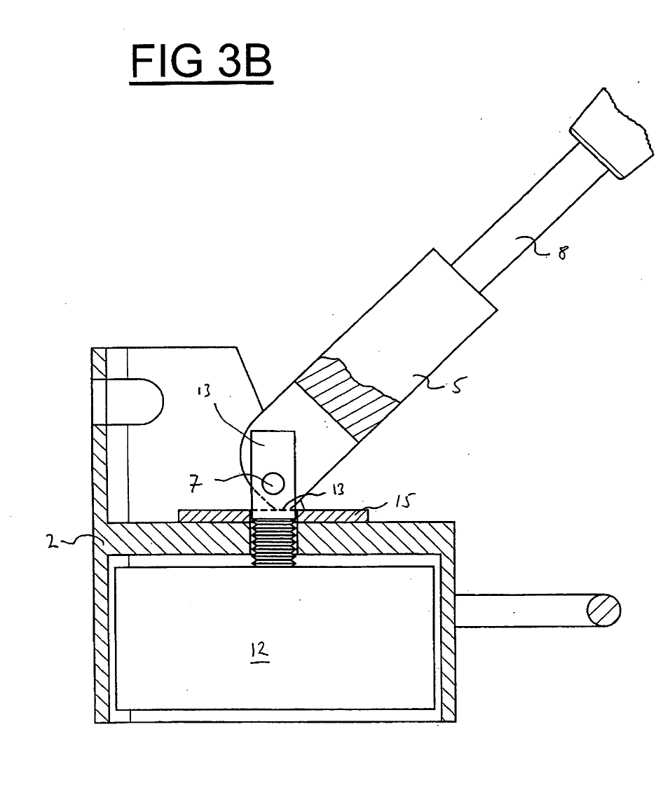

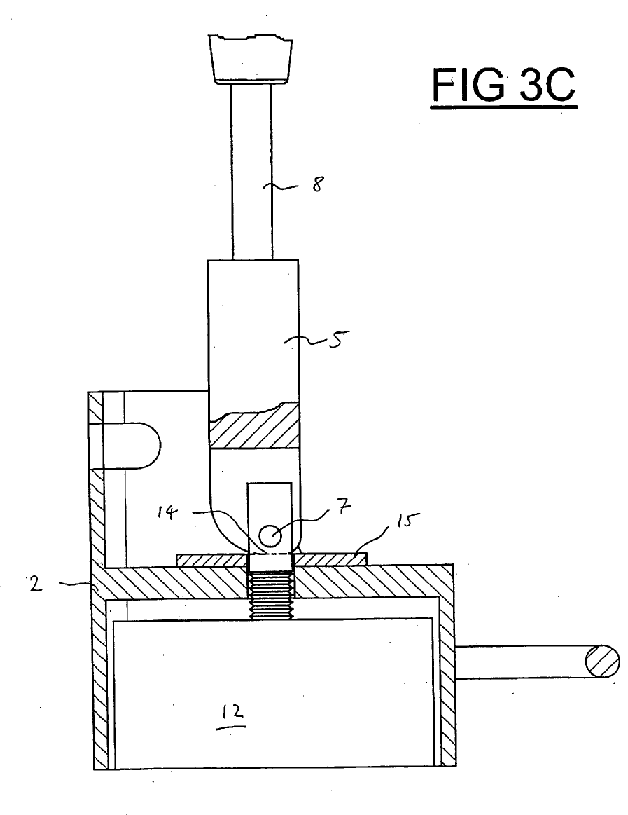

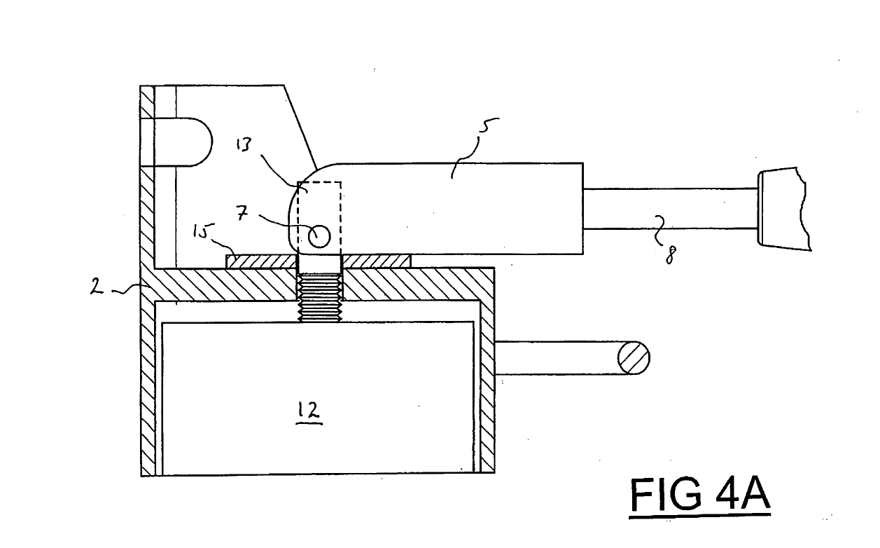

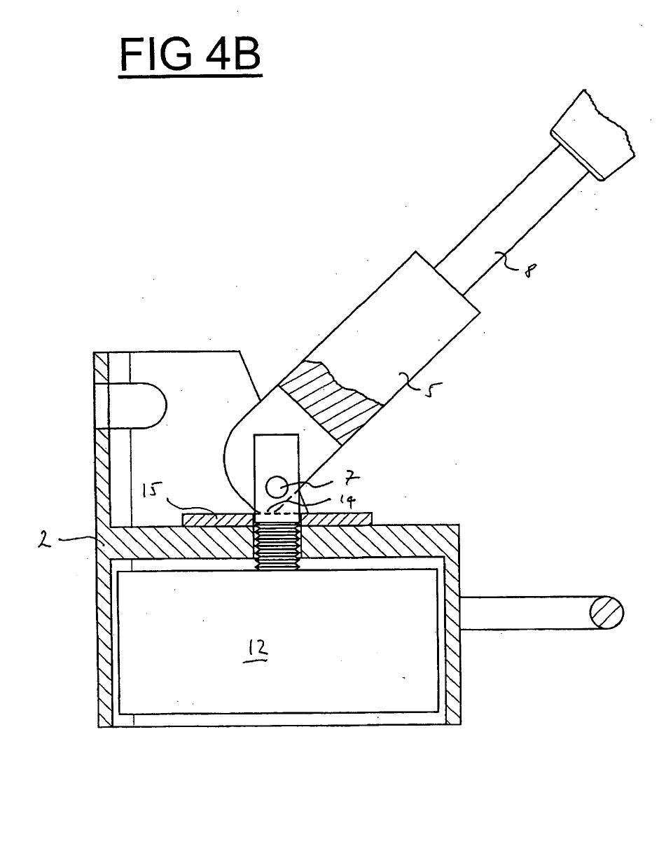

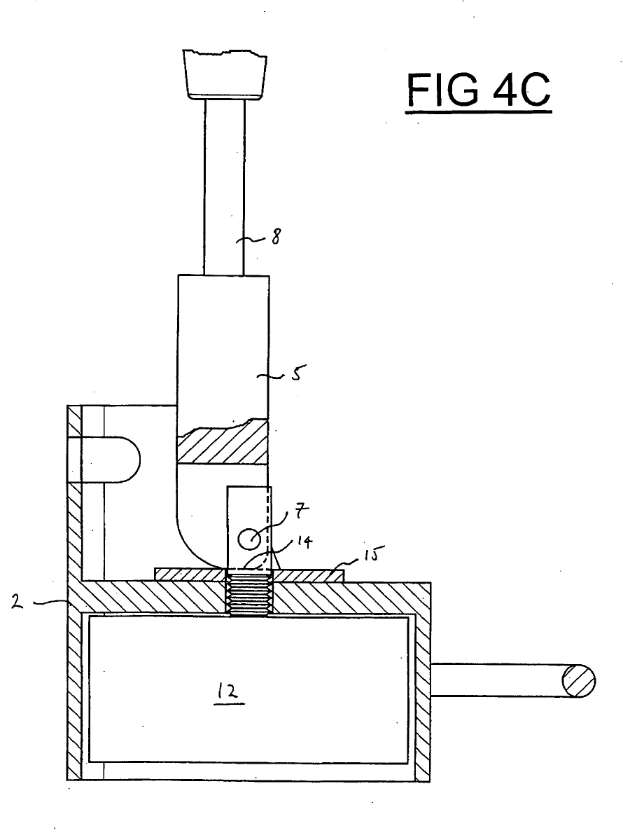

Referring now to FIG. 2 there is illustrated a preferred form of the 20 support device 1 in an exploded view. FIG. 2 illustrates a securing means 12 which is intended to secure the support device 1 to a formwork surface (not shown). In a preferred form the securing means 12 is a magnet. In accordance with the illustration the switch means 3 is linked to the magnet member 12 via the link member 6. The link member 6 illustrated is in the form of a shank 13 having an aperture to receive the pin 7 of the switch means 3. The link member 6 extends from the magnet member 12 and it is preferred that the link member be releaseably secured to the magnet member, which means of securing is illustrated more appropriately in FIGS. 3 and 4. This form of link member is not essential and other forms may be considered appropriate.

Referring now to FIG. 3A there is illustrated the support device with the securing means 12 in the non-operating condition. The link member 6 illustrated includes a threaded male portion to be received by a threaded female recess in the magnet member 12.

Referring now to FIG. 3B the cam member 5 is rotated about the pin 7 causing a cam surface 14 of the cam member 5 to slide relative to a bearing plate 15 positioned between the cam member 5 and the upper surface 4 of the structure 2. This rotation of the cam member 5 along with the asymmetric location of the pin 7 relative to the cam surface 14 causes the magnet member 12 to move relative to the structure 2. The curved cam surface 14 illustrated is merely preferred and not essential to the invention. Clearly the cam member 5 could operate without a curved cam surface.

Referring now to FIG. 3C the cam member 5 is rotated to a substantially upright position thereby lowering the magnet member 12 to the operating condition. Clearly this form of operation of the cam member 5 is not essential, and more specifically it is clearly possible for the cam surface to operate in the reverse condition as illustrated by FIGS. 4A to 4C.

It should be appreciated that as there is no force, such as a spring force, acting against the magnetic force when the securing means 12 is in the operating condition, the switching means 3 will not switch the securing means 12 unintentionally to the non-operating condition. As such once the securing means 12 has been switched to the operating condition, the support device 1 is relatively secure.

Referring now to FIG. 5 the preferred form of the support device 1 is illustrated when connected to a formwork member 16. A pair of fastening means 17 in the form of nuts and bolts extend through the apertures 11 in the flange 10 of the structure 2 thereby securing the formwork member 16 to the structure 2. It should be noted that the apertures 11 provided are in the form of ovals so as to provide a certain degree of manipulation between the formwork member 16 and the structure 2.

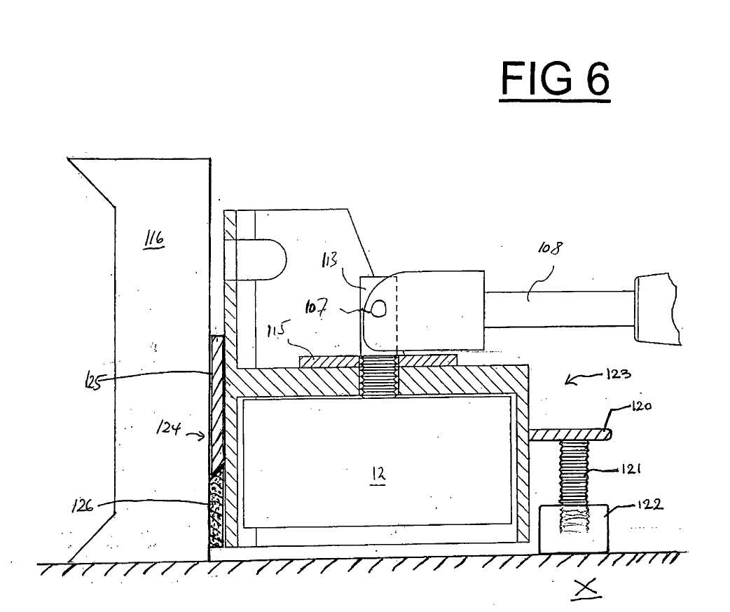

Referring now to FIG. 6, another preferred embodiment of the present invention (support device 101) is shown in the non-operating condition resting on a formwork surface X. Support device 101 is similar to that shown in FIGS. 1 to 5, but it also includes a plate 120 extending out from the rear face 123 of the support device—the face that does not engage the formwork member. Extending away from plate 120 toward the formwork surface, is a threaded shank 121. The shank does not extend all the way to the base of the support device, as there is room provided for a foot 122 to be threaded on the shank to adjust the effective height of the rear face of the support device relative to the formwork surface. The foot 122 is adjusted is by rotation along the length of shank 121 varying the effective height of the shank/foot combination, and the effective height of the rear face 123.

The front face or engaging side 124 of the structure 102 has a face which engages the formwork member 116. This face includes a wedge 125, which complements a wedge 126 formed on the formwork member 116. Wedges 124 and 126 may be bolted or screwed onto their respective components. The support device 101 is placed on formwork member 116 so that the wedges 125 and 126 are aligned, suspending engaging side 124 of the support device 101 over the formwork surface X. Foot 122 is adjusted so that the opposite face or non-engaging side 123 is also supported above the formwork surface X. Foot 122 can be adjusted to vary the spacing of non-engaging side 123 relative to formwork surface X to compensate for irregularities in the formwork surface. Foot 122 is formed as a threaded opening having an external surface made from rubber so that the outer surface of foot 122 will minimize damage to the formwork surface.

In this embodiment, in the non-operating condition, the support structure 102 acts like a propped beam—supported at the engaging side 124 by the formwork member and at the non-engaging side 123 by the adjustable height means (120,121,122) or the support structure 102. It is not necessary for the adjustable height means to suspend the non-engaging side 123 above the formwork surface. As the magnet member 112 is not yet activated, the support device 101 can be orientated and adjusted as desired before switching the support device 101 to the operating condition.

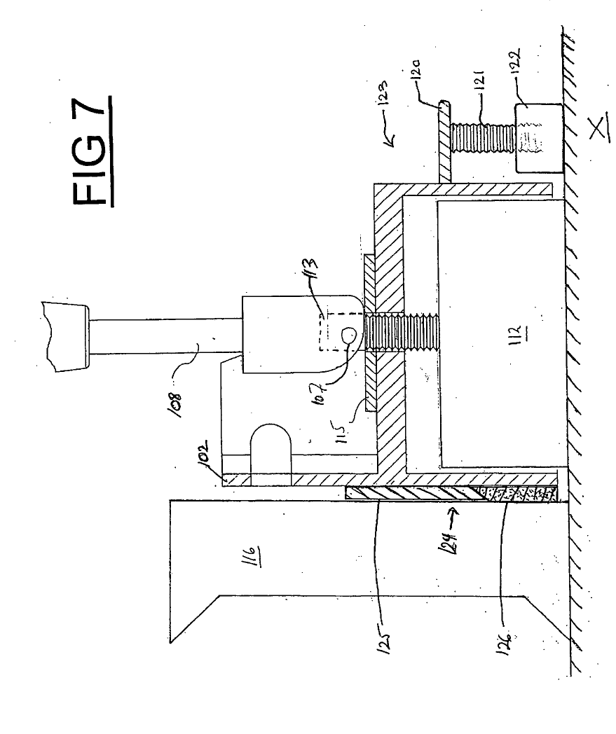

In FIG. 7 we see support device 101 in the operating condition. The switching means 3 has been activated by rotating cam member 105 so that the magnet member 112 can engage the formwork surface X. When magnet member 112 does secure to the formwork surface, its attractive force pulls on switch means 103 via link member 106 to cam member 105 against the upper surface 104 of the support structure. This force is then transferred through the support structure to sides 123 and 124 pulling the support structure 102 towards the formwork surface. On rear side 123, the foot 122 is able to absorb some of these forces so that the formwork surface is not damaged. On side 124, wedge 125 transfers the force on wedge 126 of formwork member 116, applying a restraining force on formwork member 116 into the formwork surface X and restraining it in the desired position. No additional connection means are required to keep the formwork member in the desired position on the formwork surface.

The non-engaging side can make contact with the formwork surface if the adjustable height means is not included, but in this preferred embodiment, the engaging side should be suspended above the formwork surface, to transfer the force on the support structure to the formwork member in a direction towards the formwork surface.

It should be noted that the rotation of cam member 105 used shown in FIGS. 6 and 7 is rotated from horizontal to a substantially upright position thereby lowering the magnet member 12 to the operating condition. Clearly this form of operation of the cam member 105 is not essential, and more specifically it is clearly possible for the cam surface to operate in the reverse condition.

Advantageously, using one or more of the above embodiments, a series of support devices can be easily placed on a formwork surface for supporting one or more formwork members. The support device of the invention is suitable for a wide variety of formwork members, as the connection means or engaging means provided can be adjust for nearly all types of formwork members. The formwork surface does not need to be modified to secure the formwork member as the support device achieves this. Accordingly, the formwork surface does not need to be repaired after every use.

It should be appreciated that the support device in accordance with the invention is appropriate for the corrosive construction environment. Furthermore it should also be appreciated that the support device in accordance with the invention is more likely to function predictably than other systems.

Finally, it is to be understood that various alterations, modifications and/or additions may be introduced into the constructions and arrangements of parts previously described without departing from the spirit or ambit of the invention.

1. A support device for supporting a formwork member adjacent to a formwork surface, including:
a support structure positionable in use adjacent the formwork surface;
a magnetic element movable relative to the support structure, the magnetic element configured to secure the support device to the formwork surface;
a switching device coupled to the magnetic element, the switching device being rotatable between an operating position wherein in the operating position the magnetic element secures the support device to the formwork surface, and a non-operating position wherein in the non-operating position the magnetic element does not secure the support device to the formwork surface,
wherein in use the formwork member located adjacent the formwork surface is supported by the support device.

2. A support device as claimed in claim 1 wherein the switching device moves the magnetic element so that in the non-operating position, the magnetic element is spaced from the formwork surface.

3. A support device as claimed in claim 1 wherein the switching device rotates about a rotation axis, the rotation axis being an axis substantially parallel with the formwork surface.

4. A support device as claimed in claim 1 wherein the switching device includes a cam member which is connected to the magnetic element.

5. A support device as claimed in claim 4 wherein the support structure is preferably in the form of a housing which at least in part surrounds the magnetic element, the cam member being located on the outside surface of the support structure, and wherein the cam member engages the support structure along a cam surface, so that movement of the cam member along the cam surface causes the magnetic element to switch between the operating and non-operating conditions.

6. A support device as claimed in claim 4 wherein the cam member includes a lever extending from the cam member.

7. A support device as claimed in claim 4 wherein the cam member includes a lever that is detachably coupled to the cam member.

8. A support device as claimed in claim 4 wherein the switching device includes a link member linking the cam member with the magnetic element.

9. A support device as claimed in claim 8 wherein the link member is formed with the magnetic element.

10. A support device as claimed in claim 8 wherein the link member has a complimentary engagement with the magnetic element.

11. A support device as claimed in claim 8 wherein the link member connects with the cam member via a pivotal connection.

12. A support device as claimed claim 1 wherein the support structure includes a flange provided with at least one aperture to receive a fastening means for fastening the formwork member to the flange.

13. A support device as claimed in claim 1, including a tilt adjuster for varying the tilt or level of the support structure relative to the formwork surface.

14. A support device as claimed in claim 13 wherein the tilt adjuster is preferably located on a face of the support structure opposite to a face that engages the formwork member.

15. A support device for supporting a formwork member adjacent to a formwork surface, including:
a support structure positionable in use adjacent the formwork surface;
a magnetic element movable relative to the support structure, the magnetic element configured to secure the support device to the formwork surface;
a switching device coupled to the magnetic element, the switching device being rotatable between an operating position wherein in the operating position the magnetic element secures the support device to the formwork surface, and a non operating position wherein in the non-operating position the magnetic element does not secure the support device to the formwork surface,
wherein in use the formwork member located adjacent the formwork surface is supported by the support device;
further wherein the support structure includes:
an engaging side, and at least one non-engaging side, the engaging side having an engaging member;
wherein in the operating position, the support structure is forced toward the formwork surface and the engaging member exerts a force on the formwork member toward the formwork surface.

16. A support device as claimed in claim 15 wherein the engaging member engages the formwork member so that the engaging side is spaced from the formwork surface.

17. A support device as claimed in claim 15 wherein the non-engaging side includes an adjustable height jack configured to selectively adjust the height of the non-engaging side of the support structure, relative to the engaging side of the support structure with respect to the formwork surface.

18. A support device as claimed in claim 17 wherein operation of the adjustable height jack rotates the support structure and/or formwork member relative to the formwork surface.

19. A support device as claimed in claim 15 wherein the non-engaging side includes a plate extending from the non-engaging side; at least one shank extending from the plate towards the formwork surface; and at least one complimentary foot, each foot being adjustable along the length of each shank, whereby adjustment of the foot adjusts the height of the non-engaging side of the support structure, relative to the engaging side of the support structure with respect to the formwork surface.

20. A support device as claimed in claim 19 wherein adjustment of the foot rotates the support structure and/or formwork member relative to the formwork surface.

21. A support device as claimed in claim 19 wherein only one non-engaging side is included and located on the side opposite the engaging face.

22. A support device as claimed in claim 15 wherein the switching device moves the magnetic element so that in the non-operating position, the magnetic element is spaced from the formwork surface.

23. A support device as claimed in claim 15 wherein the switching device rotates about a rotation axis, the rotation axis being an axis substantially parallel with the formwork surface.

24. A support device as claimed in claim 15 wherein the switching device includes a cam member which is connected to the magnetic element.

25. A support device as claimed in claim 24 wherein the support structure is preferably in the form of a housing which at least in part surrounds the magnetic element, the cam member being located on the outside surface of the support structure, and wherein the cam member engages the support structure along a cam surface, so that movement of the cam member along the cam surface causes the magnetic element to switch between the operating and non-operating conditions.

26. A support device as claimed in claim 24 wherein the cam member includes a lever extending from the cam member.

27. A support device as claimed in claim 24 wherein the cam member includes a lever that is detachably coupled to the cam member.

28. A support device as claimed in claim 24 wherein the switching device includes a link member linking the cam member with the magnetic element.

29. A support device as claimed in claim 28 wherein the link member is formed with the magnetic element.

30. A support device as claimed in claim 28 wherein the link member has a complimentary engagement with the magnetic element.

31. A support device as claimed in claim 28 wherein the link member connects with the cam member via a pivotal connection.

32. A support device as claimed in 1 wherein the support device is formed with the formwork member.

33. A support device for supporting a formwork member adjacent to a formwork surface, including:
a support structure positionable in use adjacent the formwork surface;
a securing means associated with the structure being operable for securing the support device to the formwork surface, and being movable relative to the support structure;
a switching means being rotatably switchable for switching the securing means between an operating condition whereby the securing means secures the support device to the formwork surface, and a non operating condition whereby the securing means is not securing the support device to the formwork surface,
wherein in use the formwork member located adjacent the formwork surface is supported by the support device.

34. A support device for supporting a formwork member adjacent to a formwork surface, including:
a support structure positionable in use adjacent the formwork surface;
a securing means associated with the structure being operable for securing the support device to the formwork surface, and being movable relative to the support structure;
a switching means being rotatably switchable for switching the securing means between an operating condition whereby the securing means secures the support device to the formwork surface, and a non operating condition whereby the securing means is not securing the support device to the formwork surface,
wherein in use the formwork member located adjacent the formwork surface is supported by the support device
wherein the support structure includes:
an engaging side having engaging means for engaging the formwork member, and at least one non-engaging side
so that in the non-operating condition, the engaging side is spaced from the formwork surface, and in the operating condition, the support structure is forced toward the formwork surface applying a force on the engaging means to force the formwork member toward the formwork surface.
